(19) United States
(12) Patent Application Publication
(10) Pub. No.: US 2007/0060382 A1
(43) Pub. Date: Mar. 15, 2007

(54) Game device and game system

(75) Inventor: Takuya Ando, Tokyo (JP)

Correspondence Address: SUGHRUE-265550, 2100 PENNSYLVANIA AVE. NW, WASHINGTON, DC, 20037-3213, US

(73) Assignee: KONAMI CORPORATION, Tokyo (JP)

(21) Appl. No.: 10/555,277

(22) PCT Filed: Mar. 10, 2004
(86) PCT No.: PCT/JP04/03052

§ 371 Date: Nov. 2, 2005

(30) Foreign Application Priority Data
May 2, 2003 (JP) 2003-127490

(51) Int. Cl. A63F 9/24; A63F 13/00

(52) U.S. Cl. 463/43; 463/25

(57) ABSTRACT

Each of a plurality of stations, at which a player plays a game, is provided with an identifier unique to each of the stations, and a receiver which receives personal information from the player. A first storage stores the personal information while associating with the identifier, with respect to each of the stations. A second storage stores a first play record of the player while associating with the personal information, with respect to each of the stations. A judge which judges whether there exists a second play record which satisfies a first prize requirement among the first play records stored in the second storage. A first specifier specifies a player who satisfies the first prize requirement in a case where there exists the second play record, with reference to the personal information associated with the second play record. A second specifier specifies a station at which the player specified by the first specifier plays, with reference to the identifier associated with the personal information referred by the first specifier. A condition arranger changes a condition of the game performed at the station specified by the second specifier so as to be more advantageous to the player specified by the first specifier, and maintains the changed condition until a cancel condition is satisfied.

### TECHNICAL FIELD

The present invention relates to a game machine and a game system, in which play conditions are made advantageous for a player when the player satisfies a prize requirement.

### BACKGROUND ART

In a conventional racing game such as a horse race game or a boat race game, players guess results of races and make bets, and dividends are paid to the players according to results of each race.

Game machines have been known, in which a player plays a second race by betting dividends obtained by a first race (for example, see Japanese Patent Publication No. 1-57592B). This game machine provides a game simulating the so-called horse race, boat race, bicycle race, or the like in which each of a plurality of rows of lamps are sequentially turned on at a changing rate and which is played by guessing the row of lamps that arrives at a goal point first or the order or combination of arrivals of those rows.

In such a game, however, ratios (odds) determining dividends paid to the players are the same for all players, and no advantage or disadvantage is introduced between the players depending on the record of the game. Therefore, a player has no close relation to other players, and no sense of rivalry is therefore aroused between the players.

Incidentally, it is assumed that a racing game as described above can be played in such a manner that the challenging spirit and curiosity of the players is inspired if there is a technique for arousing a sense of rivalry between the players.

### DISCLOSURE OF THE INVENTION

It is an object of the invention to provide a game machine and game system which inspire the curiosity and challenging spirit of players by classifying the players based on the records of the players in the game.

In order to achieve the above object, according to the invention, there is provided a gaming machine, comprising:

a plurality of stations, each of the stations, at which a player plays a game, being provided with:
an identifier, unique to each of the stations; and
a receiver, which receives personal information from the player;

a first storage, which stores the personal information while associating with the identifier, with respect to each of the stations;

a second storage, which stores a first play record of the player while associating with the personal information, with respect to each of the stations;

a judge, which judges whether there exists a second play record which satisfies a first prize requirement among the first play records stored in the second storage;

a first specifier, which specifies a player who satisfies the first prize requirement in a case where there exists the second play record, with reference to the personal information associated with the second play record;

a second specifier, which specifies a station at which the player specified by the first specifier plays, with reference to the identifier associated with the personal information referred by the first specifier, and

a condition arranger, which changes a condition of the game performed at the station specified by the second specifier so as to be more advantageous to the player specified by the first specifier, and maintains the changed condition until a cancel condition is satisfied.

With this configuration, since the play condition as a prize varies from player to player, the players are inspired to competition with each other. As a result, it is possible to arouse the challenging spirit of the layers and to stimulate the curiosity of the players.

Preferably, the first prize requirement is arranged in each of a plurality of classes. This allows the challenging sprit and curiosity of a player to be aroused because the player will play the game in an intention to win a level at which the player will be given a more advantageous play condition.

Here, it is preferable that the first prize requirement in higher one of the classes is more difficult to be satisfied.

With this configuration, a player can be given a particular level and a play condition in playing the game when he or she satisfies the prize requirement which is more difficult than an achievement previously recorded by another player, which makes it possible to arouse a sense of rivalry between players. As a result, it is possible to arouse the challenging spirit of players and to inspire their curiosity.

Preferably, a first amount of a gaming value is inputted by each player to execute the game, and a second amount of the gaming value is outputted to each player as a result of the game. A ratio of a total of the second amount to a total of the first amount converges on 100% or less.

With this configuration, since the payout amount will not exceed 100%, an entity owing this game machine can secure profit.

Here, the gaming machine further comprises: an accumulator, which accumulates a third amount of the gaming value which is a predetermined ratio of the first amount; and a bonus presenter, which outputs all the gaming value accumulated in the accumulator is outputted to a station associated with a player who satisfies a second prize requirement.

With this configuration, an advantage, for example, in the form of a jackpot can be given to a player who has won a certain prize as the second prize requirement to inspire the curiosity of the player. As a result, the racing game simulating a horse race or the like can be added with an element of play which has not existed so far, and the curiosity of players can be inspired. A player can be more strongly motivated to win a level, the greater the accumulated amount associated with the level. Further, an actual payout rate can be adjusted to a preset value by paying out credits accumulated as a jackpot.

Preferably, the game is a racing game in which a plurality of racing members perform a racing. The player bets the first amount of the gaming value with respect to at least one of the racing members. The player obtains the second amount of the gaming value in accordance with the result of the game and odds. The condition of the game includes at least the odds.

With this configuration, advantages or handicaps can be given to players in a racing game simulating a horse race, a boat race or the like, which makes it possible to arouse a sense of rivalry between the players. Further, the game can be added with a novel element in that a play condition is won in association with a particular class.

According to the invention, there is also provided a gaming system, comprising a master machine and a plurality of gaming machines, connected with each other via a network, each of the above gaming machines, wherein the master machine manages at least the personal information in each of the gaming machines.

Preferably, one of the gaming machines serves as the master machine.

Preferably, a first amount of a gaming value is inputted by each player to execute the game, and a second amount of the gaming value is outputted to each player as a result of the game. The master machine manages the second amount of the gaming value in each of the gaming machines, such that a ratio of a total of the second amount to a total of the first amount converges on 100% or less, for each of the gaming machines.

With this configuration, the above-described operations and effects can be achieved, for example, game machines in different amusement arcades.

### BRIEF DESCRIPTION OF THE DRAWINGS

FIG. 1 is a perspective view showing an external appearance of a game machine according to a first embodiment of the invention;

FIG. 2 is a block diagram showing an electrical configuration of the game machine of FIG. 1;

FIG. 3 is a table showing examples of male player levels used in the game machine of FIG. 1;

FIG. 4 is a table showing examples of female player levels used in the game machine of FIG. 1;

FIG. 5 is a table showing examples of titles used in the game machine of FIG. 1;

FIGS. 6 to 11 are flow charts showing operations of the game machine of FIG. 1;

FIG. 12 is a block diagram showing an electrical configuration of a game machine according to a second embodiment of the invention; and

FIGS. 13 to 18 are flow charts showing operations of the game machine of FIG. 12.

### BEST MODE FOR CARRYING OUT THE INVENTION

Embodiments of the invention will now be described in detail with reference to the drawings.

In a game machine according to a first embodiment of the invention, when a recorded play result satisfies a prize requirement as a result of a determination, the player who has achieved the play result is identified; a play terminal operated by the identified player is identified; and a play condition at the identified play terminal is set more advantageous for the player than when the prize requirement is not satisfied. The setting is maintained until a cancellation requirement is satisfied.

The prize requirement means a requirement which is determined by a play result of a player and fulfillment of which allows the player to play with an advantage. For example, it means a requirement that 5000 or more medals should be won as a dividend in one play. The prize requirement is set within such a range that a payout rate will not exceed a predetermined value. The play condition is a condition which is applied to a game machine to allow the game to be played with an advantage when the prize requirement is satisfied. For example, a condition under which a game can be played with a 6% increase in odds.

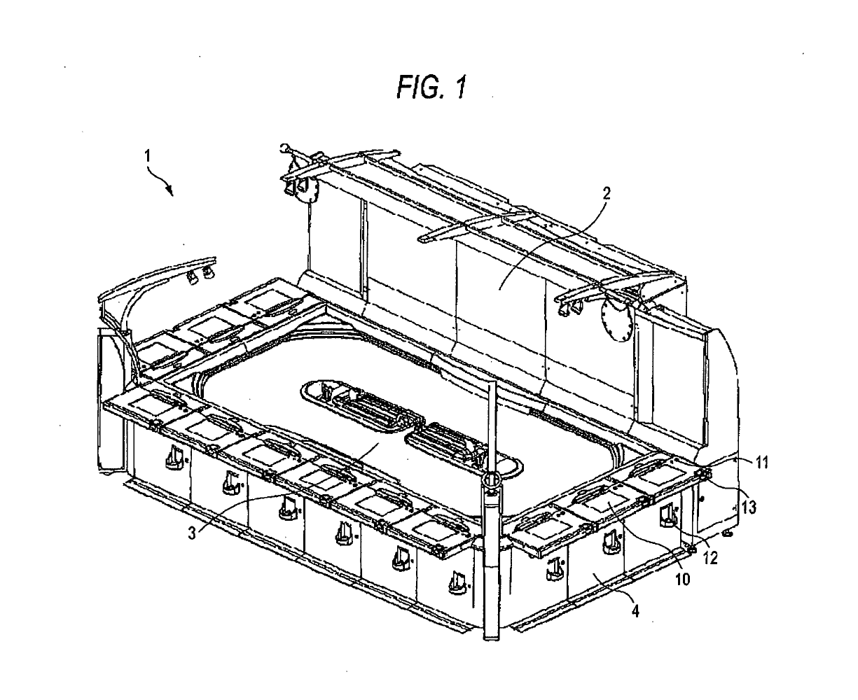

As shown in FIG. 1, a game machine 1 according to the first embodiment of the invention comprises an image display terminal 2 constituted by three large displays, a miniature racing section 3 as a field unit, and a plurality of play terminals 4. The miniature racing section 3 as a field unit comprises a plurality of miniatures of racing bodies which are made to race and a miniature field. A play terminal 4 is what is called station, and it is a section operated by each player to play the game. Each play terminal includes an interface 10, a medal input slot 11, a medal payout port 12, and a card insertion slot 13. A card is used for storing personal information that identifies a player. The interface 10 not only has the function of displaying game results and the like but also serves as an input terminal when a betting operation is performed.

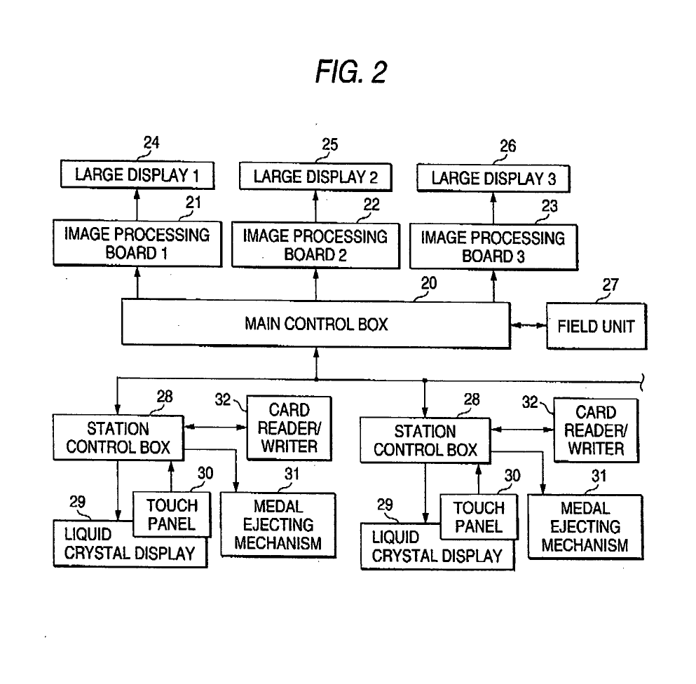

As shown in FIG. 2, the game machine 1 comprises a main control box 20, image processing boards 21 to 23, large displays 24 to 26, a field unit 27, a station control box 28, a liquid crystal display 29, a touch panel 30, and a medal ejecting mechanism 31. The liquid crystal display 29 and the touch panel 30 are included in the interface 10, and the touch panel 30 is provided over the liquid crystal display 29. The main control box 20 is connected to the image processing boards 21 to 23, the field unit 27, and the station control box 28, and it has the function of controlling image processing, operations of the racing bodies in the field, and operations of the stations.

The image processing boards 21 to 23 have the function of controlling display operations of the large displays 24 to 26. The station control box 28 has the function of controlling operations of the liquid crystal display 29, the touch panel 30, the medal ejecting mechanism 31, and a card reader/writer 32. A magnetic card is used as a player identifier for associating a play record that is stored with a player. The card reader/writer 32 serves as a personal information input section for reading personal information of a player stored in the card. Personal information for identifying each person is written in a magnetic card, and a player inserts his or her own magnetic card into the card reader/writer 32 to retrieve a play record recorded in the main control box 20 of the main body, and the player can enjoy a continuation of the game which has been played until that time. When a game is temporarily terminated, a card ejection button on the station 4 may be pressed to save the play record at that time in the main control box 20 of the main body.

While a card is used in the first embodiment, the use of a card does not constitute a limitation, and a password or the like may be used as long as it allows a player to be identified.

A player inputs expectation data through the touch panel 30, and the input data is recorded in the main control box 20. That is, the touch panel 20 and the main control box serve as an expectation data input section. The main control box 20 also serves as a prize determinant for determining a prize based on race result data and the input expectation data.

The main control box 20 has the function of transmitting race result data and receiving payout data to and from each station control box 28. The main control box 20 has the function of memorizing the past play record of each player (the number of times the game has been played, the cumulative total of bets, the cumulative total of medals paid out, and the like). The station control box 28 has the function of determining a prize. When a payout operation is performed, the medal ejecting mechanism 31 pays a medal from the medal payout port.

The game machine in the first embodiment makes a determination based on the play record of a player to qualify the level of performance of the player in the horse race game.

Personal information of a player is recorded in the main control box 20 as a personal information storage in association with ID information set in the game machine. Since ID information that is unique to a play terminal is recorded in association with personal information as described above, it is possible to know which player is at which game machine. As a result, even when a player moves between play terminals, since the personal information is input again at the new play terminal, a process can be performed to accommodate the player properly. As thus described, pieces of ID information are set for the play terminals themselves and players themselves, and they are recognized by the game machine as thus described. It is therefore possible to determine whether there is a player who has achieved a result sufficient to be allowed to play under advantageous conditions and, if yes, to identify the play terminal where the player stays.

The main control box 20 also operates as a result storage for storing play results in association with the personal information in the personal information storage. It is thus found which player has played to satisfy the prize requirement.

The main control box 20 also operates as a determinant for determining whether a play result recorded in the result storage satisfies the prize requirement that is defined in advance and as a condition setting portion for setting a play condition at a play terminal based on the result of the determination at the determinant.

With the game machine of the first embodiment, a player participating the game guesses the result of a race simulating a horse race and makes a bet (votes) on each of win, perfecta, and quinella betting tickets, and the credit is paid back according to predetermined odds (rate) when it is a winning ticket.

A player can simultaneously bet on a plurality of tickets if the credits in his or her possession allow, but the number of bets that can be made on one betting ticket is limited to a maximum of 50 in principle.

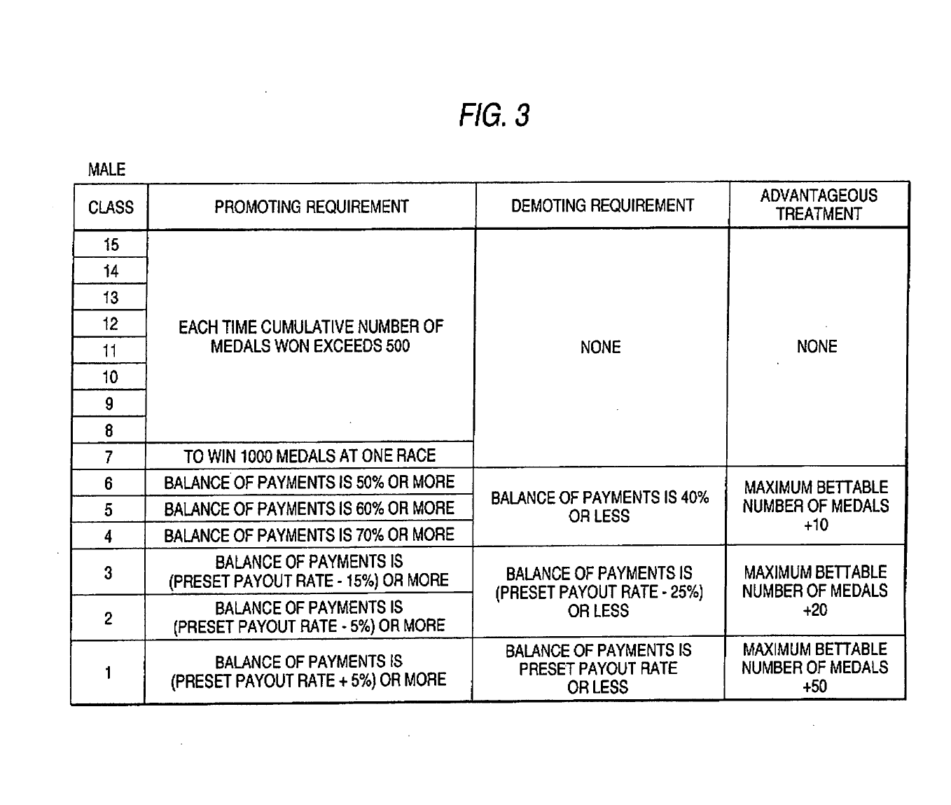

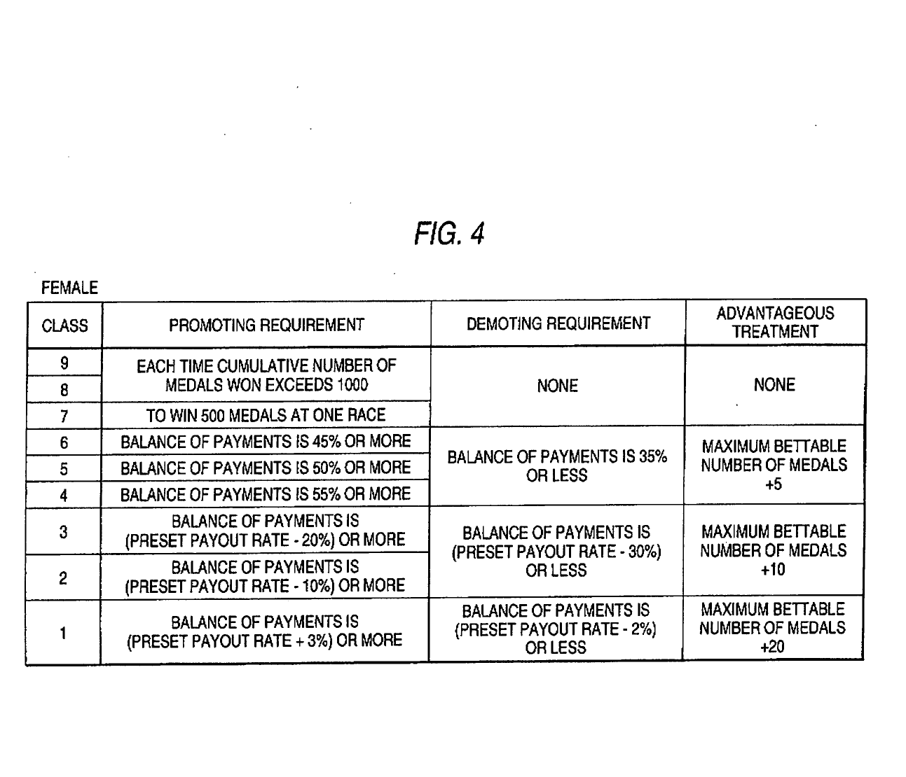

According to the invention, classes are set in association with conditions for advantage. Play conditions are set for the classes. FIGS. 3 to 5 are tables showing examples of hierarchies. In the first embodiment, hierarchies are defined, which are classified depending on the sex of players as shown in FIGS. 3 and 4. A class that is uniquely determined in association with each player will be referred to as a player level. A player level will not be transferred between players unlike a title which will be described later. Most women are normally unfamiliar with games such as horse races, and player levels to which players can belong are provided differently depending on the sex of players in the first embodiment. As a result, a woman can participate in the game with ease. Referring to the identification of a man or woman, information input at initial setting is recorded in the main control box 20 in association with personal information in the card. The classification allows the challenging sprit and curiosity of a player to be aroused because the player will play the game in an intention to win a level at which the player will be given a more advantageous play condition. A player is promoted and demoted one class at a time, and there is no skipping.

The conditions for promotion and demotion in the figures correspond to the conditions for advantage, and the advantageous treatments correspond to the play conditions. As shown in FIG. 3, in the case of a male player, Class 15 is initially set for him. As the promoting requirement for Classes 15 through 8, a requirement that promotion should take place each time the cumulative number of medals won exceeds 500 is set. 1000 or more medals must be won at one race for promotion to Class 7. Neither demoting requirement nor advantageous treatment is defined for the classes up to Class 7.

The promoting requirement for Classes 6 to 4 is that the balance of payments should equal or exceed 50%, 60%, and 70% at the respective classes. The term “balance of payments” means the ratio of the cumulative number of medals paid out to the cumulative number of bets of the player in terms of percentage. For example, the term applies to the ratio of the cumulative number of medals paid out to the cumulative number of bets from a point in time when a player temporarily participates in the game, i.e., a point in time when new data is generated as a result of the insertion of a new card. The term may also apply to the ratio of the cumulative number of medals paid to the cumulative number of bets in the past until now.

The demotion requirement is that the balance of payments is 40% or less and, in such a case, demotion of one class takes place. As an advantageous treatment in Classes 6 to 4, the maximum number of bets is increased by 10 from the previous number, i.e., 50 to a total of 60. In general, a betting ticket having high probability of winning is given low odds and is less attractive as a betting ticket. However, since an increase in the maximum number of bets results in a corresponding increase in a payback, such a betting ticket becomes more attractive.

Since the play condition as an advantageous treatment varies between players as thus described, the players will have a sense of rivalry to each other. It is therefore to arouse the challenging spirit of the players and to inspire their curiosity.

The condition for promotion to Class 3 is that the balance of payments is equal to or higher than a value reached by subtracting 15% from a preset value of a payout rate, and the condition for promotion to Class 9 is that the balance of payment is equal to or higher than a value reached by subtracting 5% from the preset value of the payout rate. The payout rate is normally set about 90%, although it may vary between game spots. The demotion requirement from Class 3 to Class 2 is that the balance of payments is equal to or lower than a value reached by subtracting 25% from the preset value of the payout rate. In this, case, demotion of one class takes place. As an advantageous treatment at Classes 3 and 2, the maximum number of bets is increased by 20 from 50 to a total of 70. The condition of promotion to Class 1 is that the balance of payments is equal to or higher than a value reached by adding 5% to the preset value of the payout rate. The demotion requirement from Class 1 is that the balance of payments is equal to or lower than the preset value of the payout rate. In this case, demotion to Class 2 takes place. As an advantageous treatment at Class 1, the maximum number of bets is increased by 50 from 50 to a total of 100.

As shown in FIG. 4, player levels are similarly defined for women in classes from Female Class 9 to Female Class 1. The requirements for promotion and demotion are relaxed in comparison to those for men, and advantages are set smaller instead. Thus, women will feel free to take part in the game.

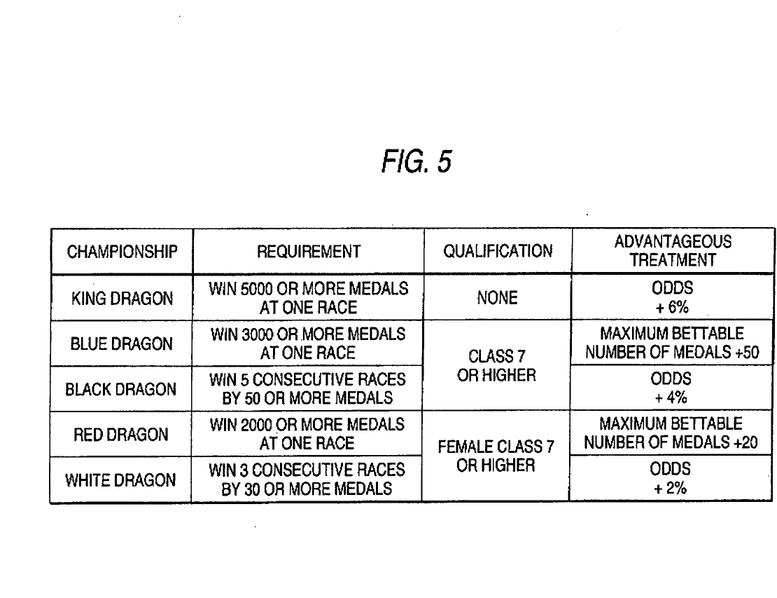

As shown in FIG. 5, five titles are prepared in game machines according to the first embodiment in addition to the above-described player levels, the titles allowing a player to play the game more advantageously than usual.

Only one of those titles is prepared in one game machine and is given to a player who has satisfied a requirement for winning the same. An entitled player can play the game under an advantageous condition according to the title until another player newly satisfies the winning condition or until one week passes after the title is won.

As a result, advantages or handicaps can be given to players in a racing game simulating a horse race, which makes it possible to arouse a sense of rivalry between the players. Further, the game can be added with a novel element in that a play condition is won in association with a particular level.

As shown in FIG. 5, a winning requirement and a qualification for a challenge correspond to the prize requirement in this case. The cancellation requirement of a title is that another player newly satisfies the condition for winning it or that one week passes after it is won. An advantageous treatment corresponds to a play condition just as in the case of a player level as described above. Since a title is lost one week after it is won, the title will not be possessed by one player exclusively for a long time, and players can therefore be strongly motivated to win the title.

A condition for winning a title named King Dragon is to get 5000 or more medals at one race, and all players having a certain player level are qualified to challenge it. When a player already has King Dragon, a new condition is added, which requires another player to get medals in a quantity in the excess of the number of medals that the player has got to win King Dragon.

Thus, a player can be given a particular level and a play condition in playing the game when he or she satisfies the prize requirement at a level higher than an achievement previously recorded by another player, which makes it possible to arouse a sense of rivalry between players. As a result, it is possible to arouse the challenging spirit of players and to inspire their curiosity.

A cancellation requirement of King Dragon is that another player newly satisfies the condition for wining the same or that one week passes after the title is won. An advantageous treatment for King Dragon is an addition of 6% to normal odds. The increase in odds allows a player to receive a payout in an amount greater than those to other players who have betted on the same betting ticket. A player holding the title King Dragon can receive six more medals than other players each time 100 medals are paid out.

Blue Dragon is a title which can be won only by men. A condition for winning Blue Dragon is to get 3000 or more medals at one race, and a man whose player level is Class 7 or higher is qualified to challenge the same. When a player already has Blue Dragon, a new condition is added, which requires another player to get medals in a quantity in the excess of the number of medals that the player has got to win Blue Dragon. In order to prevent one player from winning two or more titles at one race, a player who has newly won the title Blue Dragon is disallowed to win the title Blue Dragon at that race.

A cancellation requirement of Blue Dragon is that another player newly satisfies the condition for wining the same or that one week passes after the title is won. An advantageous treatment for Blue Dragon is an increase of 50 in the maximum number of bets.

Red Dragon is a title which can be won only by women and which corresponds to Blue Dragon for men. A condition for winning Red Dragon is to get 2000 or more medals at one race unlike Blue Dragon, and a woman whose player level is Female Class 7 or higher is qualified to challenge the same. A cancellation requirement of Red Dragon is the same as the condition for Blue Dragon. An advantageous treatment for Red Dragon is an increase of 20 in the maximum number of bets.

Black Dragon is a title which can be won only by men. A condition for winning Black Dragon is to win five consecutive races by 50 or more medals, and a man whose player level is Class 7 or higher is qualified to challenge the same. What is meant by winning by 50 or more medals is that the number of medals paid as a dividend minus the total number of bets is 50 or more per race. When a player already has Black Dragon, a new condition is added, which requires another player to win consecutive races by 50 medals or more in a number of times beyond the maximum number of consecutive wins of the player. In order to prevent one player from winning two or more titles at one race, a player who has newly won the title King Dragon or Blue Dragon is disallowed to win the title Black Dragon at that race.

A cancellation requirement of Black Dragon is that another player newly satisfies the condition for wining the same or that one week passes after the title is won.

An advantageous treatment for Black Dragon is an addition of 4% to the normal odds. In the case of a player who holds King Dragon and Black Dragon at the same time, an addition of 10% in total, i.e., 6% for King Dragon and 4% for Black Dragon is made to the normal odds.

White Dragon is a title which can be won only by women and which corresponds to Black Dragon for men. Unlike Black Dragon, a condition for winning White Dragon is to win three consecutive races by 30 or more medals, and a woman whose player level is Female Class 7 or higher is qualified to challenge the same.

A cancellation requirement of Red Dragon is similar to that for Black Dragon. An advantageous treatment for White Dragon is an addition of 2% to the normal odds. In the case of a player who holds King Dragon and White Dragon at the same time, an addition of 8% in total, i.e., 6% for King Dragon and 2% for White Dragon is made to the normal odds.

The game machine in the first embodiment can provide a novel appeal, i.e., competition with other players by putting players in competition with each other for those titles which provide a holder of them with an advantage.

As thus described, an addition to odds or the like is prescribed as an advantageous treatment in the first embodiment. Alternatively, a player having a particular title may be allowed to make a bet in such a way that the player will win a race when specified horses finish in the first to third places beyond the limit of the conventional way of quinella betting. Various other advantageous treatments that provide a player with an advantage may alternatively be prescribed.

Normally, a payout rate is set in medal game machines including the game machine in the first embodiment. For the administration of a game facility, there is a strong demand for the convergence of the payout rate of a medal game machine. A medal game machine is disqualified when the above-described additions to odds as advantageous treatments are made without limit because the payout rate will not converge at a preset value in that case,

Under the circumstance, values added to odds must be set within such a limit that a payout rate properly converges. In the game machine of the first embodiment, odds are calculated by the following expression.
odds (times)=payout rate (%)/the probability of winning of a betting ticket (%)
For example, when a payout rate of 90% is set, a betting ticket having a probability of 7% of winning is given odds as follows:
90(%)/7(%)=12.8571 . . . (times)
However, only digits up to the first decimal place are used for the odds of a horse race in the game machine of the first embodiment, and the second and later decimal places (0.0571) are round down. Therefore, the payout rate finally converges slightly short of the preset value. A result of a simulation has indicated that the value of the shortage to the preset value is about 1%. That is, if there is an addition of 1% to the odds on average at all of the twelve stations, the payout rate will converge to equal the preset value.

The payout rate similar converges at the preset value even in case that an addition of 12% is made only at one of the twelve stations (=1% by 12 stations). It is therefore appropriate to distribute preset values for additions to the odds as the advantageous treatments for the titles such that they will total at 12%. In the first embodiment, therefore, additions of 6%, 4%, and 2% are set for King Dragon, Black Dragon, and White Dragon, respectively.

As a result, there will be no payout in the excess of a limit, and a party who carries on business with a game machine according to the invention can keep a profit. In the past, any deviation of an actual payout rate generated by omitting fractions of odds has been adjusted by setting a day for some event or the like. In the case of a game machine according to the invention, such a deviation can be corrected by adjusting play conditions to achieve a set payout rate.

There has been a tendency that omitted fractions of odds are reflected in the profit of an amusement arcade to some extent, and an adjustment has been carried out in this connection to return the payout rate to the original preset value by setting a day for a special event or the like for returning the profit to players. According to the conventional method involving a day for adjustment, it is inevitable to produce some special event for the purpose, to total payout rates until the day, and to contrive how to distribute the total at each event which has been a problem bothering people concerned with an amusement arcade.

According to the inventive technique, however, additions to odds are distributed by setting advantageous treatments for titles such that the payout rate will converge at a preset value without exceeding the preset value. As a result, the distribution can be carried out during normal operations without setting a day for adjustment as described above. Obviously, there will be no influence of dividends to players who are not qualified for advantages.

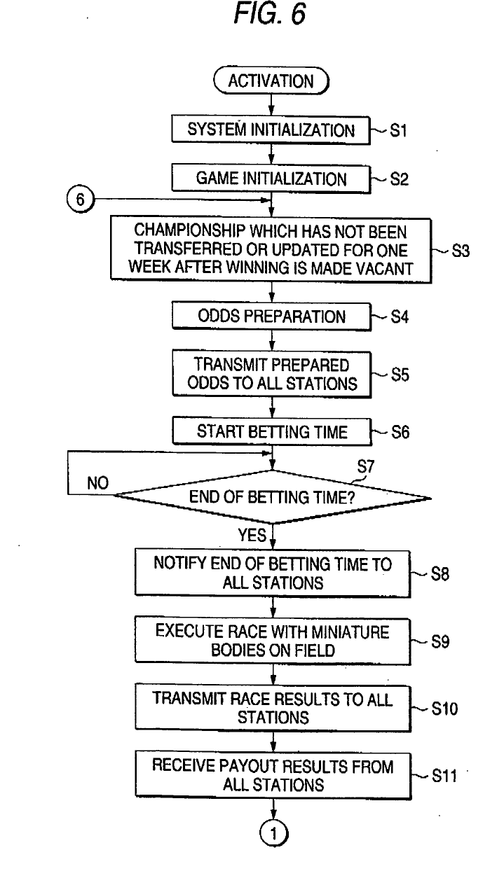

Operations of the game machine according to the first embodiment having the above-described configuration will now be described using flow charts in FIGS. 6 to 11.

As shown in FIG. 6, when the power supply of the game machine is activated, system initialization and game initialization is first carried out (steps S1 and S2). A title which has not been transferred or updated for one week after it was won becomes vacant (step S3).

Next, odds are created at the main control box 20 (step S4), and the created odds are transmitted to all stations (step S5). The odds transmitted to the stations 4 are displayed on the liquid crystal displays 29.

Then, a betting time starts (step S6). It is determined whether the betting time has ended (step S7). If the betting time has not ended, a player can make a bet through the touch panel. The contents of bets are recorded as expectation data in the station control boxes 28. When the betting time ends, all stations are notified of the fact that the betting time has ended (step S8).

Next, a race is held using the miniatures of racing bodies on the field of the miniature racing section 3 (step S9). At the same time, the race is displayed on the large display 2. When the race ends, the results of the race are transmitted to all stations (step S10). The station control box 28 at each station determines whether any prize has been won from the data of the race results and the expectation data and makes payment if any prize has been won. The main control box 20 receives payout results from all stations (step S11).

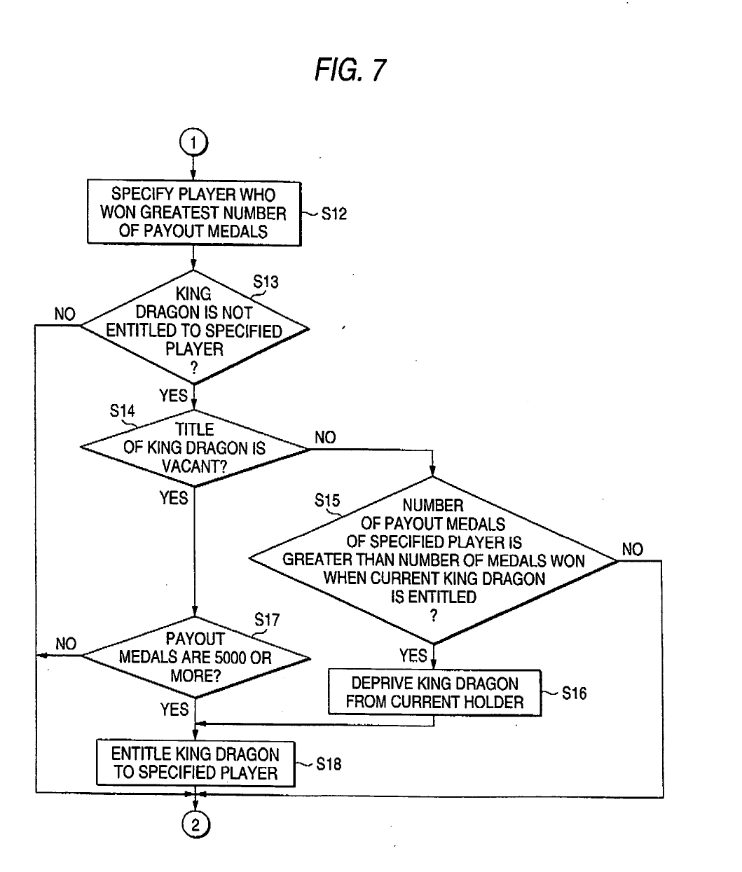

Next, a King Dragon title transfer process as shown in FIG. 7 is carried out. First, the main control box 20 selects the player to whom the greatest number of medals have been paid out (step S12) and determines whether the player has the title of King Dragon or not (step S13). If the player has the title of King Dragon, the King Dragon title transfer process is terminated. If the player does not have the title of King Dragon, it is determined whether the title of King Dragon is vacant or not (step S15). If the title of King Dragon is not vacant, it is determined whether the number of medals paid out to the player as a result of the last race is greater the number of medals paid out to the current holder of the title of King Dragon when King dragon was won (step S14). If not, the King Dragon title transfer process is terminated. If yes, the current holder of the title of King Dragon is deprived of the title of King Dragon (step S16), and the title of King Dragon is given to the selected player (step S18).

When the title of King Dragon is vacant, it is determined whether the number of medals paid out to the player as a result of the last race is equal to or greater than 5000 (step S17). If the number is less than 5000, the King Dragon title transfer process is terminated. If the number is equal to or greater than 5000, the title of King Dragon is given to the player (step S18).

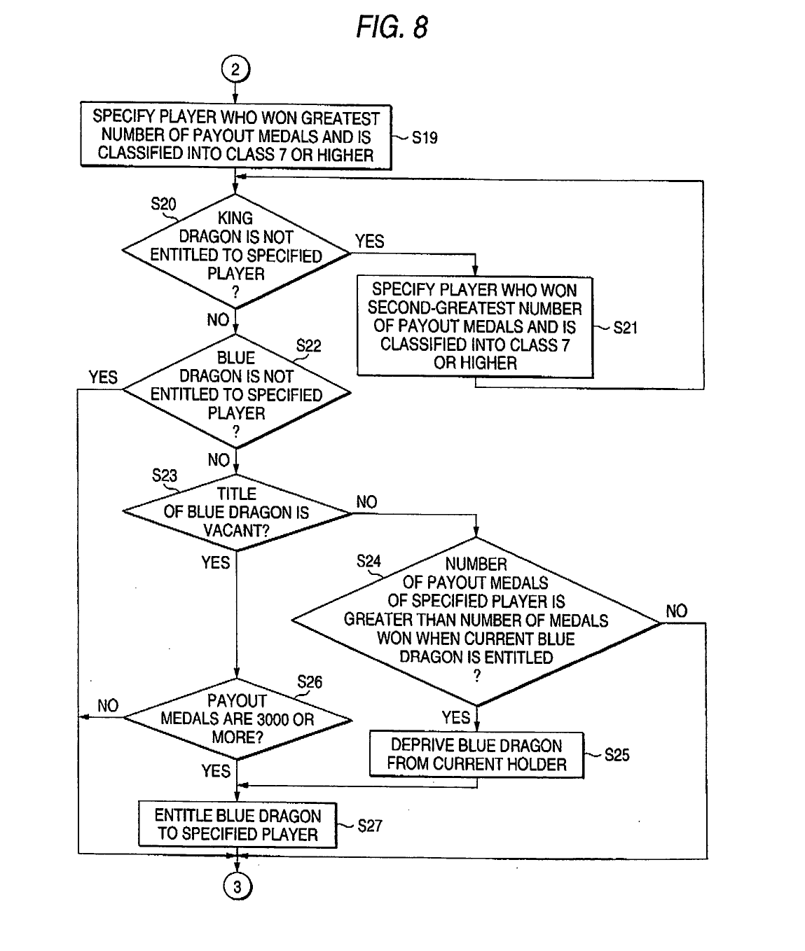

Next, a Blue Dragon title transfer process as shown in FIG. 8 is carried out. First, the main control box 20 selects the player at a player level of Class 7 or higher to whom the greatest number of medals have been paid out (step S19) and determines whether the player has won King Dragon as a result of the last race (step S20). If the player has won King Dragon this time, the player at a player level of Class 7 or higher to whom the second greatest number of medals have been paid out is selected (step S21). Next, it is determined whether the player thus selected has the title of Blue Dragon or not (step S22). If the player has the title of Blue Dragon, the Blue Dragon title transfer process is terminated. If the player does not have the title of Blue Dragon, it is determined whether the title of Blue Dragon is vacant or not (step S23). If the title of Blue Dragon is not vacant, it is determined whether the number of medals paid out to the player as a result of the last race is greater the number of medals paid out to the current holder of the title of Blue Dragon when Blue dragon was won (step S24). If not, the Blue Dragon title transfer process is terminated. If yes, the current holder of the title of Blue Dragon is deprived of the title of Blue Dragon (step S25), and the title of Blue Dragon is given to the selected player (step S27).

When the title of Blue Dragon is vacant, it is determined whether the number of medals paid out to the player as a result of the last race is equal to or greater than 3000 (step S26). If the number is less than 3000, the Blue Dragon title transfer process is terminated. If the number is equal to or greater than 3000, the title of Blue Dragon is given to the player (step S27).

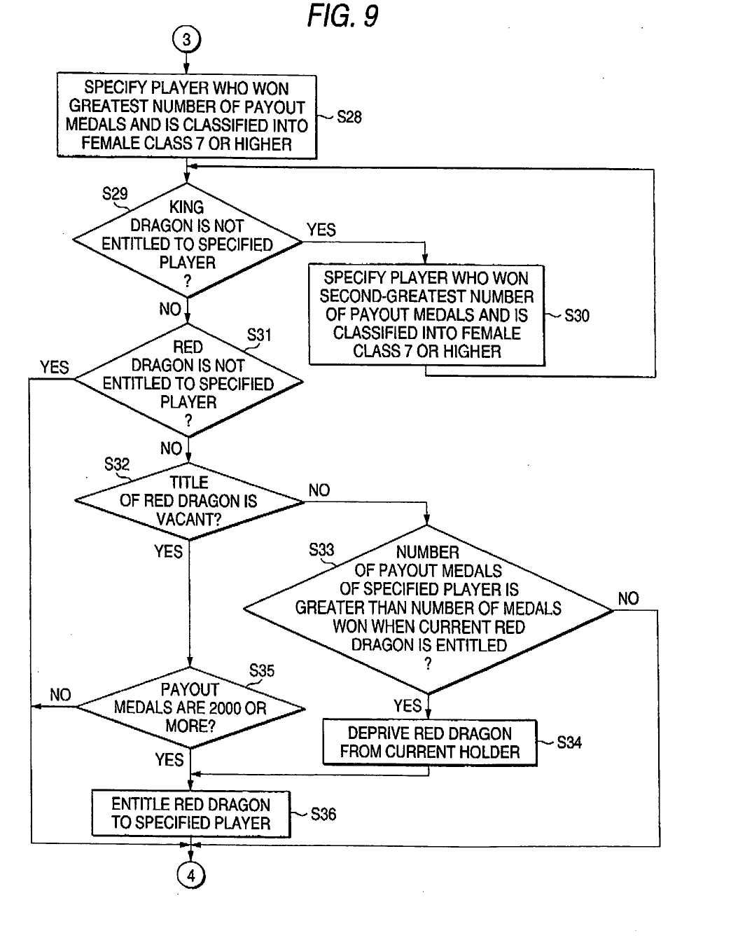

Next, a Red Dragon title transfer process as shown in FIG. 9 is carried out. First, the main control box 20 selects the player at a player level of Female Class 7 or higher to whom the greatest number of medals have been paid out (step S28) and determines whether the player has won King Dragon as a result of the laser race (step S29). If the player has won King Dragon this time, the player at a player level of Female Class 7 or higher to whom the second greatest number of medals have been paid out is selected (step S30). Next, it is determined whether the player thus selected has the title of Red Dragon or not (step S31). If the player has the title of Red Dragon, the Red Dragon title transfer process is terminated. If the player does not have the title of Red Dragon, it is determined whether the title of Red Dragon is vacant or not (step S32). If the title of Red Dragon is not vacant, it is determined whether the number of medals paid out to the player as a result of the last race is greater the number of medals paid out to the current holder of the title of Red Dragon when Red dragon was won (step S33). If not, the Red Dragon title transfer process is terminated. If yes, the current holder of the title of Red Dragon is deprived of the title of Red Dragon (step S34), and the title of Red Dragon is given to the selected player (step S36).

When the title of Red Dragon is vacant, it is determined whether the number of medals paid out to the player as a result of the last race is equal to or greater than 2000 (step S35). If the number is less than 2000, the Red Dragon title transfer process is terminated. If the number is equal to or greater than 2000, the title of Red Dragon is given to the player (step S36).

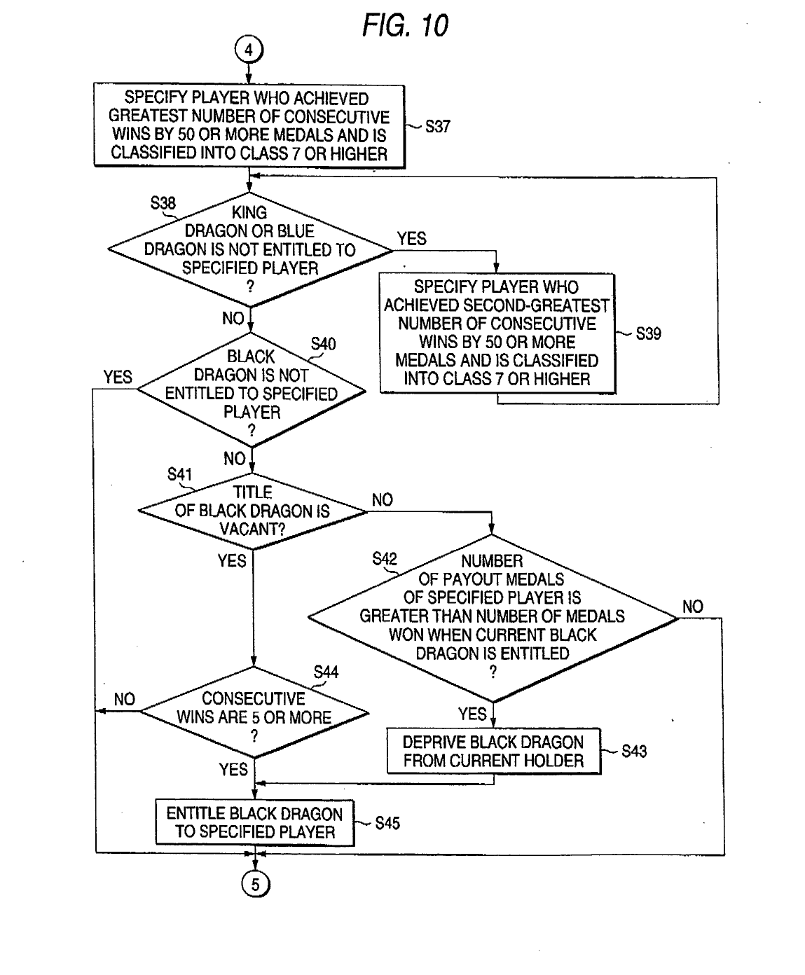

Next, a Black Dragon title transfer process as shown in FIG. 10 is carried out. First, the main control box 20 selects the player at a player level of Class 7 or higher who has achieved the greatest number of consecutive wins by 50 or more medals (step S37) and determines whether the player has won King Dragon or Blue Dragon as a result of the laser race (step S38). If the player has won King Dragon or Blue Dragon this time, the player at a player level of Class 7 or higher who has achieved the second greatest number of consecutive wins by 50 or more medals is selected (step S39). Next, it is determined whether the player thus selected has the title of Black Dragon or not (step S40). If the player has the title of Black Dragon, the Black Dragon title transfer process is terminated. If the player does not have the title of Black Dragon, it is determined whether the title of Black Dragon is vacant or not (step S41). If the title of Black Dragon is not vacant, it is determined whether the number of consecutive wins by 50 or more medals achieved by the player as a result of the last race is greater than the greatest number of consecutive wins by 50 or more medals recorded by the current holder of the title of Black Dragon (step S42). If not, the Black Dragon title transfer process is terminated. If yes, the current holder of the title of Black Dragon is deprived of the title of Black Dragon (step S43), and the title of Black Dragon is given to the selected player (step S45).

When the title of Black Dragon is vacant, it is determined whether the number of consecutive wins by 50 or more medals achieved by the player as a result of the last race is equal to or greater than five (step S44). If it is less than five, the Black Dragon title transfer process is terminated. If it is five or more, the title of Black Dragon is given to the player (step S45).

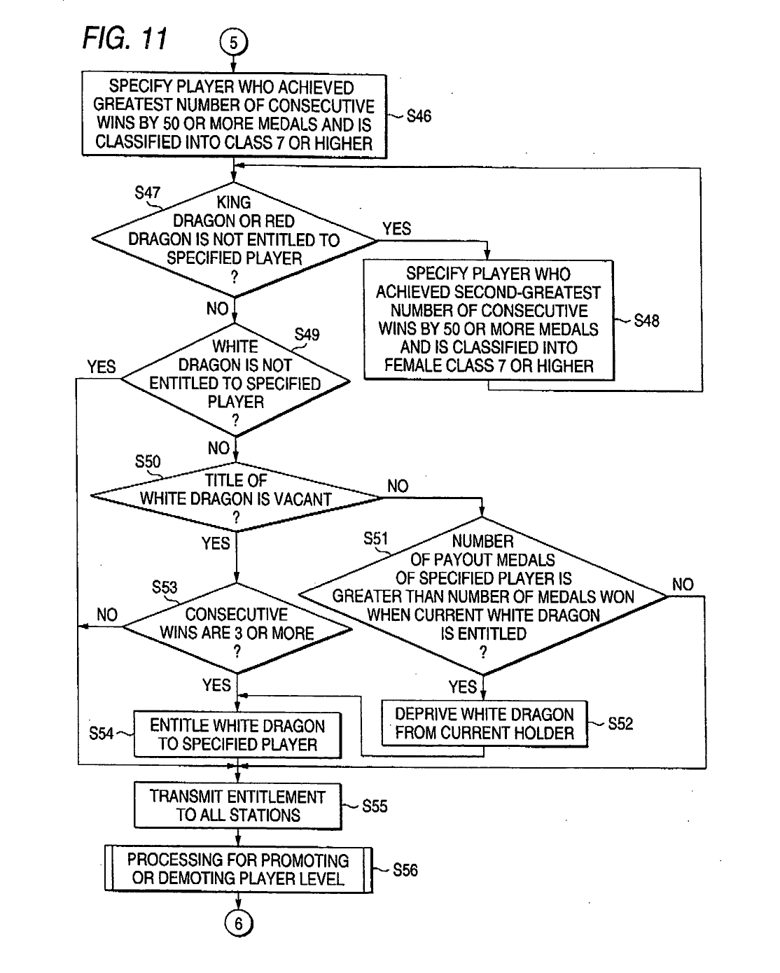

Next, a White Dragon title transfer process as shown in FIG. 11 is carried out. First the main control box 20 selects the player at a player level of Female Class 7 or higher who has achieved the greatest number of consecutive wins by 30 or more medals (step S46) and determines whether the player has won King Dragon or Red Dragon as a result of the laser race (step S47). If the player has won King Dragon or Red Dragon this time, the player at a player level of Female Class 7 or higher who has achieved the second greatest number of consecutive wins by 30 or more medals is selected (step S48). Next, it is determined whether the player thus selected has the title of White Dragon or not (step S49). If the player has the title of White Dragon, the White Dragon title transfer process is terminated. If the player does not have the title of White Dragon, it is determined whether the title of White Dragon is vacant or not (step S50) If the title of White Dragon is not vacant, it is determined whether the number of consecutive wins by 30 or more medals achieved by the player as a result of the last race is greater than the greatest number of consecutive wins by 30 or more medals recorded by the current holder of the title of White. Dragon (step S51). If not, the White Dragon title transfer process is terminated. If yes, the current holder of the title of White Dragon is deprived of the title of White Dragon (step S52), and the title of White Dragon is given to the selected player (step S54).

When the title of White Dragon is vacant, it is determined whether the number of consecutive wins by 30 or more medals achieved by the player as a result of the last race is equal to or greater than three (step S53). If it is less than three, the White Dragon title transfer process is terminated. If it is three or more, the title of White Dragon is given to the player (step S54).

After the title transfer processes are terminated, the results of title transfers are transmitted to all stations (step S55). At each station, a process of promoting or demoting the player level of the player is performed according to a criterion based on FIGS. 3 and 4 (step S56). The process then returns to step S3.

While an increase in the maximum number of bets or an addition of a prescribed value to odds is described as a play condition in the first embodiment, a so-called jackpot chance may alternatively be given to a player who satisfies a certain condition (e.g., a holder of King Dragon). Specifically, a certain percentage of numerical data of credits may be accumulated in the main control box 20, and all of the numerical data of credits accumulated may be output to the station 4 at which a player having a certain level or title is playing when a jackpot is won at the station 4.

As a result, the racing game simulating a horse race or the like can be added with an element of play which has not existed so far, and the curiosity of players can be inspired. A player can be more strongly motivated to win a level, the greater the accumulated amount associated with the level. Further, an actual payout rate can be adjusted to a preset value by paying out credits accumulated as a jackpot.

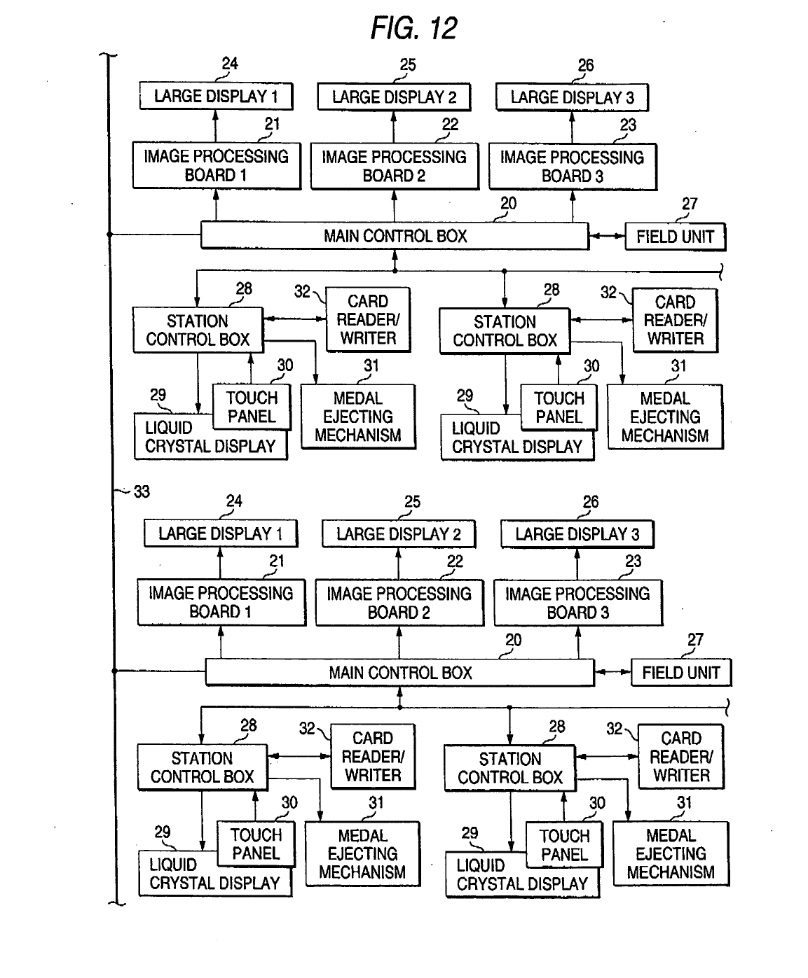

While a single game machine has been described in the first embodiment, a game system may be constructed by connecting a plurality of game machines through a network 33 as shown in FIG. 12 as a second embodiment of the invention. Each of the game machines has the same configuration as in the first embodiment. In order to orchestrate a game played at each of the game machines, one of the game machines acts as a master machine, and the other game machines act as slave machines. Information management associated with personal information of players is carried out by the main control box of the master machine. Bases for determination of player levels and titles and the like are the same as those in the first embodiment.

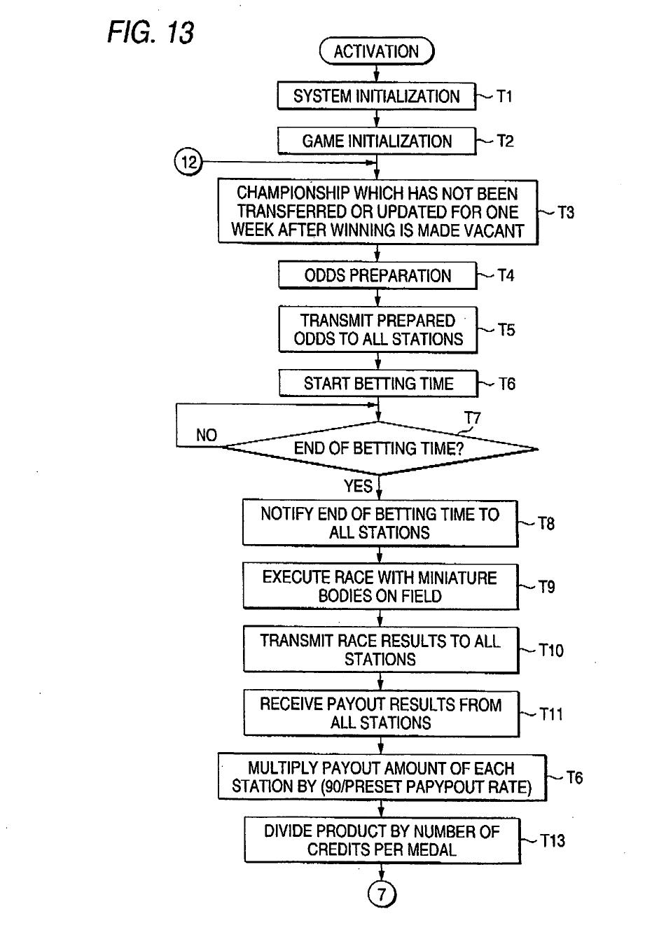

Operations of the game machines according to the second embodiment having the above-described configuration will now be described using flow charts in FIGS. 13 to 18.

As shown in FIG. 13, when the power supply of the game system is turned on, the system of each game machine is first initialized, and the game is also initialized (steps T1 and T2). A title which has not been transferred or updated for one week after it was won becomes vacant (step T3).

Next, odds are created at the main control box 20 of each game machine (step T4), and the created odds are transmitted to all stations of the game machine (step T5). The odds transmitted to the stations 4 are displayed on the liquid crystal displays 29.

Then, a betting time starts (step T6). The main control box 20 of the master machine determines whether the betting time has ended (step T7). If the betting time has not ended, players at the stations of each game machine can make a bet through the touch panels. The contents of bets are recorded as expectation data in the station control boxes 28. When the betting time ends, the master machine notifies all stations of the fact that the betting time has ended through the main control box 20 of each game machine (step T8).

Next, a race is held using the miniatures of racing bodies on the field of the miniature racing section 3 of each game machine (step T9). The same race is held by each game machine is controlled by the main control box 20 of the master machine. At the same time, the race is displayed on the large display 2 of each game machine. When the race ends, the results of the race are transmitted to all stations (step T10). The station control box 28 at each station determines whether any prize has been won from the data of the race results and the expectation data and makes payment if any prize has been won. The main control boxes 20 receive payout results from all stations, and the main control box 20 of the master machine receives the entire results (step T11).

Next, the main control box 20 of the master machine multiplies the number of medals paid out at each station by a value which is obtained by dividing 90 with a preset value of the payout rate of the game machine to which the station belongs (step T12), divides the product by the number of credits per medal (step T13), and processes the result as the number paid out.

As a result, even when two or more game machines having different payout rates are connected through the network and titles common to the plurality, of game machines are provided, players can compete for the titles under equal conditions regardless of differences between the settings of the game machines. Even when the common title is freely transferred between the plurality of game machines, any increase in the number of medals paid out caused by an increase in odds attributable to the possession of each title is compensated by medals accumulated at each game machine as a result of a 1% decrease in the actual payout rate from the preset value. Therefore, no transfer of medal values takes place between the game machines connected through the network. Referring to one of the game machines alone, the machine is therefore closed in terms of the balance of payments, which means that the payout rate of each game machine will converge at the preset value. As a result of the above-described process, the balance of payments (the number of medals input and the number of medals paid out) is completed closed in the single game machine. There is no difference between the game machines which can result in advantage or disadvantages to the players.

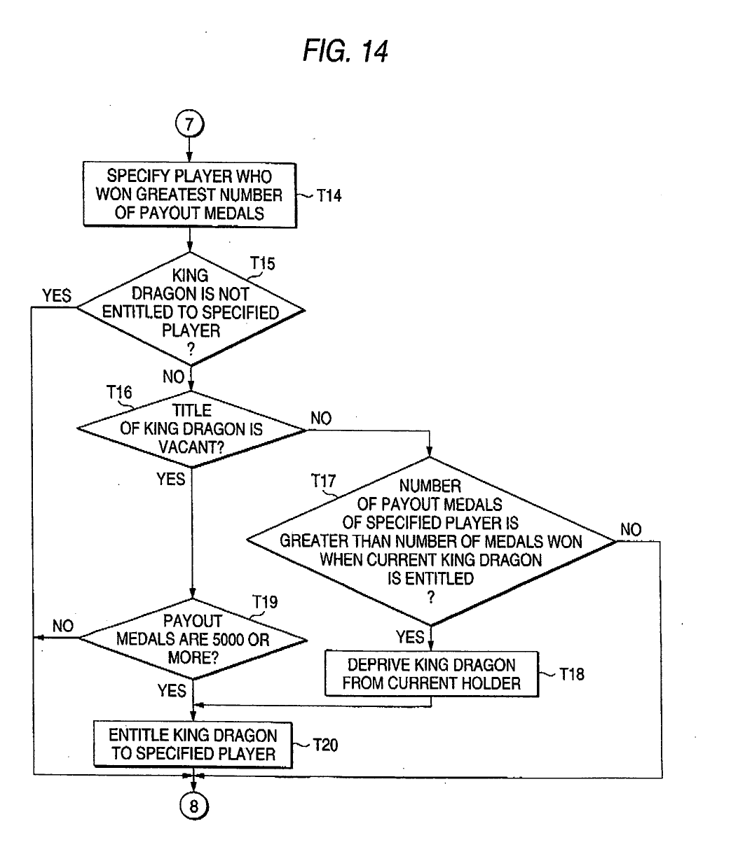

Next, a King Dragon title transfer process as shown in FIG. 14 is carried out. First, the main control box 20 of the master machine selects the player to whom the greatest number of medals have been paid out (step T14) and determines whether the player has the title of King Dragon or not (step T15). If the player has the title of King Dragon, the King Dragon title transfer process is terminated. If the player does not have the title of King Dragon, it is determined whether the title of King Dragon is vacant or not (step T16). If the title of King Dragon is not vacant, it is determined whether the number of medals paid out to the player as a result of the last race is greater the number of medals paid out to the current holder of the title of King Dragon when King dragon was won (step T17). If not, the King Dragon title transfer process is terminated. If yes, the current holder of the title of King Dragon is deprived of the title of King Dragon (step T18), and the title of King Dragon is given to the selected player (step T20).

When the title of King Dragon is vacant, it is determined whether the number of medals paid out to the player as a result of the last race is equal to or greater than 5000 (step T19). If the number is less than 5000, the King Dragon title transfer process is terminated. If the number is equal to or greater than 5000, the title of King Dragon is given to the player (step T20).

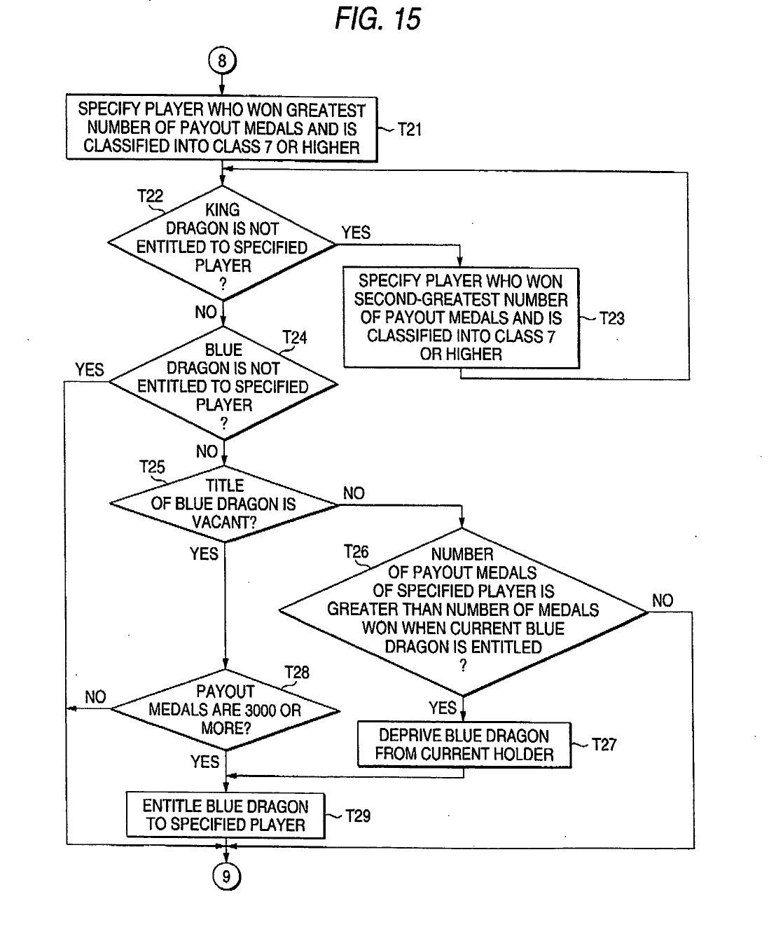

Next, a Blue Dragon title transfer process as shown in FIG. 15 is carried out. First, the main control box 20 of the master machine selects the player at a player level of Class 7 or higher to whom the greatest number of medals have been paid out (step T21) and determines whether the player has won King Dragon as a result of the last race (step T22). If the player has won King Dragon this time, the player at a player level of Class 7 or higher to whom the second greatest number of medals have been paid out is selected (step T23). Next, it is determined whether the player thus selected has the title of Blue Dragon or not (step T24). If the player has the title of Blue Dragon, the Blue Dragon title transfer process is terminated. If the player does not have the title of Blue Dragon, it is determined whether the title of Blue Dragon is vacant or not (step T25). If the title of Blue Dragon is not vacant, it is determined whether the number of medals paid out to the player as a result of the last race is greater the number of medals paid out to the current holder of the title of Blue Dragon when Blue dragon was won (step T26) If not, the Blue Dragon title transfer process is terminated. If yes, the current holder of the title of Blue Dragon is deprived of the title of Blue Dragon (step T27), and the title of Blue Dragon is given to the selected player (step T29).

When the title of Blue Dragon is vacant, it is determined whether the number of medals paid out to the player as a result of the last race is equal to or greater than 3000 (step T28). If the number is less than 3000, the Blue Dragon title transfer process is terminated. If the number is equal to or greater than 3000, the title of Blue Dragon is given to the player (step T29).

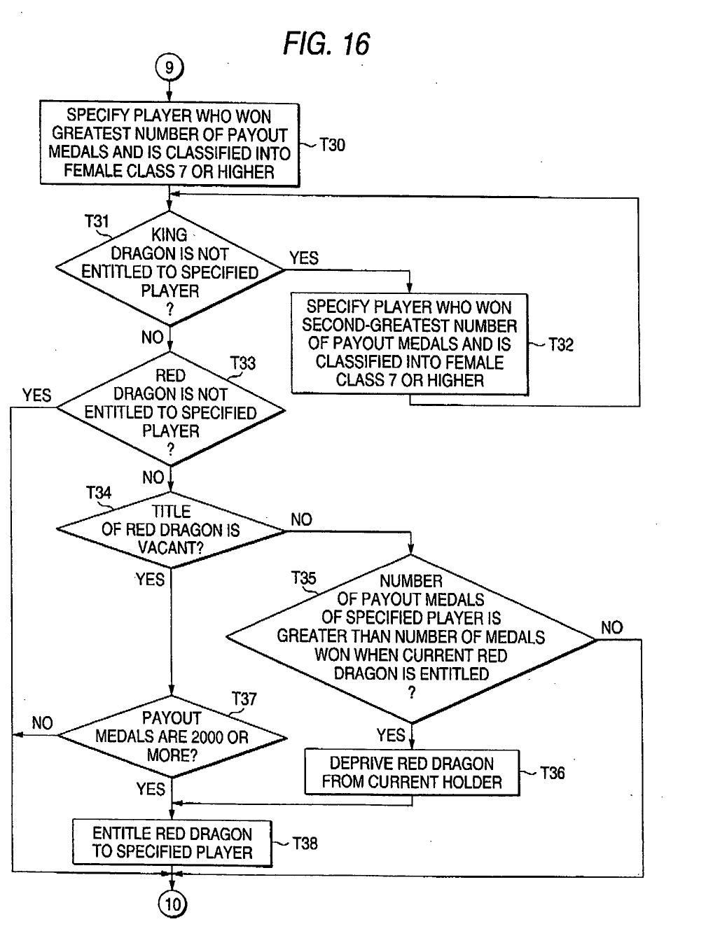

Next, a Red Dragon title transfer process as shown in FIG. 16 is carried out. First, the main control box 20 of the master machine selects the player at a player level of Female Class 7 or higher to whom the greatest number of medals have been paid out (step T30) and determines whether the player has won King Dragon as a result of the laser race (step T31). If the player has won King Dragon this time, the player at a player level of Female Class 7 or higher to whom the second greatest number of medals have been paid out is selected (step T32). Next, it is determined whether the player thus selected has the title of Red Dragon or not (step T33). If the player has the title of Red Dragon, the Red Dragon title transfer process is terminated. If the player does not have the title of Red Dragon, it is determined whether the title of Red Dragon is vacant or not (step T34). If the title of Red Dragon is not vacant, it is determined whether the number of medals paid out to the player as a result of the last race is greater the number of medals paid out to the current holder of the title of Red Dragon when Red dragon was won (step T35). If not, the Red Dragon title transfer process is terminated. If yes, the current holder of the title of Red Dragon is deprived of the title of Red Dragon (step T36), and the title of Red Dragon is given to the selected player (step T38).

When the title of Red Dragon is vacant, it is determined whether the number of medals paid out to the player as a result of the last race is equal to or greater than 2000 (step T37). If the number is less than 2000, the Red Dragon title transfer process is terminated. If the number is equal to or greater than 2000, the title of Red Dragon is given to the player (step T38).

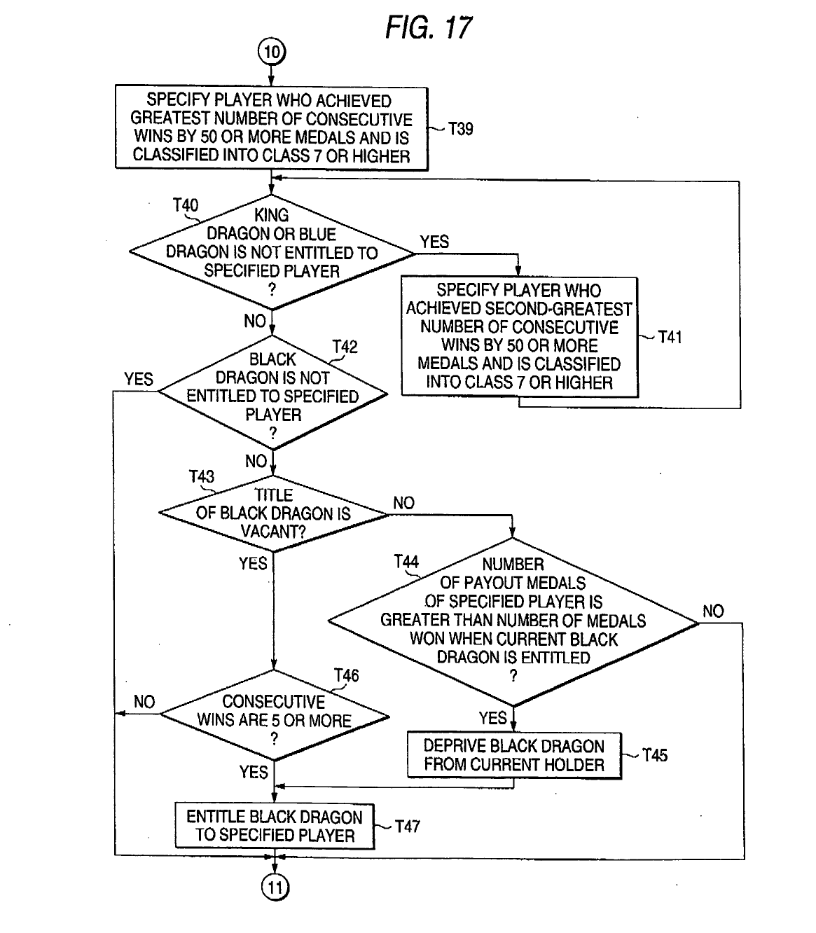

Next, a Black Dragon title transfer process as shown in FIG. 17 is carried out. First, the main control box 20 of the master machine selects the player at a player level of Class 7 or higher who has achieved the greatest number of consecutive wins by 50 or more medals (step T39) and determines whether the player has won King Dragon or Blue Dragon as a result of the laser race (step T40). If the player has won King Dragon or Blue Dragon this time, the player at a player level of Class 7 or higher who has achieved the second greatest number of consecutive wins by 50 or more medals is selected (step T41). Next, it is determined whether the player thus selected has the title of Black Dragon or not (step T42). If the player has the title of Black Dragon, the Black Dragon title transfer process is terminated. If the player does not have the title of Black Dragon, it is determined whether the title of Black Dragon is vacant or not (step T43). If the title of Black Dragon is not vacant, it is determined whether the number of consecutive wins by 50 or more medals achieved by the player as a result of the last race is greater than the greatest number of consecutive wins by 50 or more medals recorded by the current holder of the title of Black Dragon (step T44). If not, the Black Dragon title transfer process is terminated. If yes, the current holder of the title of Black Dragon is deprived of the title of Black Dragon (step T45), and the title of Black Dragon is given to the selected player (step T47).

When the title of Black Dragon is vacant, it is determined whether the number of consecutive wins by 50 or more medals achieved by the player as a result of the last race is equal to or greater than five (step T46). If it is less than five, the Black Dragon title transfer process is terminated. If it is five or more, the title of Black Dragon is given to the player (step T47).

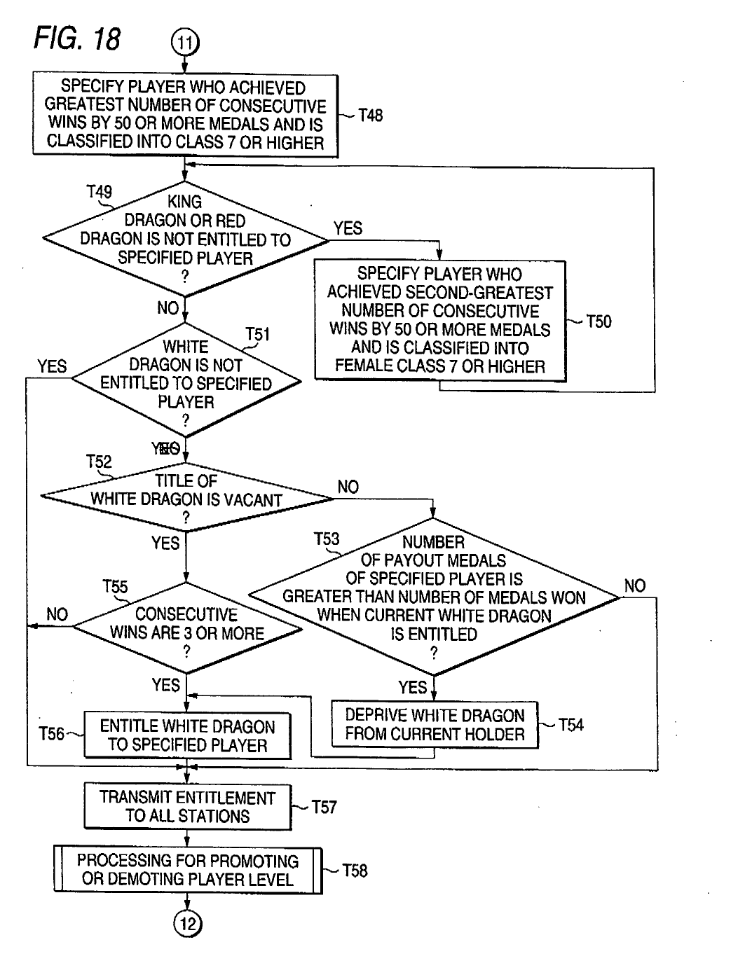

Next, a White Dragon title transfer process as shown in FIG. 18 is carried out. First, the main control box 20 of the master machine selects the player at a player level of Female Class 7 or higher who has achieved the greatest number of consecutive wins by 30 or more medals (step T48) and determines whether the player has won King Dragon or Red Dragon as a result of the laser race (step T49). If the player has won King Dragon or Red Dragon this time, the player at a player level of Female Class 7 or higher who has achieved the second greatest number of consecutive wins by 30 or more medals is selected (step T50). Next, it is determined whether the player thus selected has the title of White Dragon or not (step T51). If the player has the title of White Dragon, the White Dragon title transfer process is terminated. If the player does not have the title of White Dragon, it is determined whether the title of White Dragon is vacant or not (step T52). If the title of White Dragon is not vacant, it is determined whether the number of consecutive wins by 30 or more medals achieved by the player as a result of the last race is greater than the greatest number of consecutive wins by 30 or more medals recorded by the current holder of the title of White Dragon (step T53). If not, the White Dragon title transfer process is terminated. If yes, the current holder of the title of White Dragon is deprived of the title of White Dragon (step T54), and the title of White Dragon is given to the selected player (step T56).

When the title of White Dragon is vacant, it is determined whether the number of consecutive wins by 30 or more medals achieved by the player as a result of the last race is equal to or greater than three (step T55). If it is less than three, the White Dragon title transfer process is terminated. If it is three or more, the title of White Dragon is given to the player (step T56).

After the title transfer processes are terminated, the master machine transmits the results of title transfers to each slave machine, and each slave machine transmits the transfer results to all stations (step T57). At each station, a process of promoting or demoting the player level of the player is performed (step T58). The process then returns to step T3.

By providing titles common to a plurality of game machines as thus described, a novel appeal can be provided in that a player can compete not only with people at the single machine at which the player is playing but also with players playing at other game machines.

Specifically, conditions for advantage for each game can be updated even between game machines at different game spots and, for example, a setting can be made to allow a particular title to be transferred within the network. As a result, it is possible to construct a system in which a greater number of people can compete with each other. Thus, the challenging spirit of players can be further aroused, and their curiosity can be inspired.

While an increase in the upper limit of the maximum number of bets or an addition of a prescribed value to odds is described as a play condition in the second embodiment, a so-called jackpot chance may alternatively be given to a player who satisfies a certain condition. Specifically, a certain percentage of numerical data of credits may be accumulated in the main control box 20 of the master machine, and all of the numerical data of credits accumulated may be output to the station 4 at which a player having a certain level or title is playing when a jackpot is won at the station 4.

As a result, the racing game simulating a horse race or the like can be added with an element of play which has not existed so far, and the curiosity of players can be inspired. A player can be more strongly motivated to win a level, the greater the accumulated amount associated with the level. Further, an actual payout rate can be adjusted to a preset value by paying out credits accumulated as a jackpot.

The operations characteristic of the invention as described above are performed by having a computer execute a control program. Specifically, the control program comprises a series of processes as a group of commands that a computer can execute, the processing including: a process of setting an identifier unique to each of a plurality of stations at which a player plays a game; a process of receiving personal information from the player; a process of storing the personal information in association with the identifier at each of the stations; a process of storing a first play record of the player in association with the personal information at each of the stations; a process of specifying a player who satisfies the first prize requirement in a case where there exists the second play record, with reference to the personal information associated with the second play record; a process of specifying a station at which the specified player plays, with reference to the identifier associated with the personal information; and a process of changing a condition of the game performed at the specified station so as to be more advantageous to the specified player, and maintains the changed condition until a cancel condition is satisfied.

The above-described program can be obtained in a state in which it is recorded in a recording medium such as a CD-ROM or DVD. Such a program can be also obtained by receiving a signal transmitted from a computer serving as a transmitter through transmission media such as a communication network constituted by a public telephone line, a private telephone line, a cable television line, a radio communication line, or the like that forms a network. The signal is computer data signal in the form of a predetermined carrier wave including the program. What is required for the transmission is that at least a part of the program is transmitted in the transmission medium. Specifically, it is not essential that all data constituting the program exist on the transmission medium at a time. Methods of transmitting the program from the computer includes continuous transmission and intermittent transmission of the data constituting the program.

1. A gaming machine, comprising:
a plurality of stations, each of the stations, at which a player plays a game, being provided with:
an identifier, unique to each of the stations; and
a receiver, which receives personal information from the player;
a first storage, which stores the personal information while associating with the identifier, with respect to each of the stations;
a second storage, which stores a first play record of the player while associating with the personal information, with respect to each of the stations;
a judge, which judges whether there exists a second play record which satisfies a first prize requirement among the first play records stored in the second storage;
a first specifier, which specifies a player who satisfies the first prize requirement in a case where there exists the second play record, with reference to the personal information associated with the second play record;
a second specifier, which specifies a station at which the player specified by the first specifier plays, with reference to the identifier associated with the personal information referred by the first specifier; and
a condition arranger, which changes a condition of the game performed at the station specified by the second specifier so as to be more advantageous to the player specified by the first specifier, and maintains the changed condition until a cancel condition is satisfied.

2. The gaming machine as set forth in claim 1, wherein the first prize requirement is arranged in each of a plurality of classes.

3. The gaming machine as set forth in claim 2, wherein the first prize requirement in higher one of the classes is more difficult to be satisfied.

4. The gaming machine as set forth in claim 1, wherein:
a first amount of a gaming value is inputted by each player to execute the game, and a second amount of the gaming value is outputted to each player as a result of the game; and
a ratio of a total of the second amount to a total of the first amount converges on 100% or less.

5. The gaming machine as set forth in claim 4, further comprising:
an accumulator, which accumulates a third amount of the gaming value which is a predetermined ratio of the first amount; and
a bonus presenter, which outputs all the gaming value accumulated in the accumulator is outputted to a station associated with a player who satisfies a second prize requirement.

6. The gaming machine as set forth in claim 4, wherein:
the game is a racing game in which a plurality of racing members perform a racing;
the player bets the first amount of the gaming value with respect to at least one of the racing members;
the player obtains the second amount of the gaming value in accordance with the result of the game and odds; and
the condition of the game includes at least the odds.

7. A gaming system, comprising a master machine and a plurality of gaming machines, connected with each other via a network, each of the gaming machines being as set forth in claim 1, wherein the master machine manages at least the personal information in each of the gaming machines.

8. The gaming system as set forth in claim 7, wherein one of the gaming machines serves as the master machine.

9. The gaming system as set forth in claim 7, wherein:
a first amount of a gaming value is inputted by each player to execute the game, and a second amount of the gaming value is outputted to each player as a result of the game; and
the master machine manages the second amount of the gaming value in each of the gaming machines, such that a ratio of a total of the second amount to a total of the first amount converges on 100% or less, for each of the gaming machines.
